(19) United States
(12) Patent Application Publication
(10) Pub. No.: US 2014/0120432 A1
(43) Pub. Date: May 1, 2014

(54) BUBBLE REMOVING DEVICE FOR AN ION FILTER IN A FUEL CELL SYSTEM

(71) Applicants: HYUNDAI MOTOR COMPANY, Seoul (KR); KIA MOTORS CORPORATION, Seoul (KR)

(72) Inventors: Sung Wook Na, Yongin (KR); Hun Woo Park, Namyangju (KR)

(73) Assignees: KIA MOTORS CORPORATION, Seoul (KR); HYUNDAI MOTOR COMPANY, Seoul (KR)

(21) Appl. No.: 13/705,731

(22) Filed: Dec. 5, 2012

(30) Foreign Application Priority Data
Nov. 1, 2012 (KR) 10-2012-0122846

(51) Int. Cl. H01M 8/04

(52) U.S. Cl. CPC H01M 8/04044
USPC 429/410

(57) ABSTRACT

Disclosed is a bubble removing device for an ion filter of a fuel cell system, in which bubbles generated from cooling water passing through an ion resin are discharged outside the ion filter and are easily removed. The bubble removing means may be installed in an ion filter located on a top portion in the fuel cell system, to thereby maximize the power efficiency and heat emission efficiency of the fuel cell system.

### CROSS-REFERENCE TO RELATED APPLICATION

This application claims under 35 U.S.C. §119(a) the benefit of Korean Patent Application No. 10-2012-0122846 filed on Nov. 1, 2012, the entire contents of which are incorporated herein by reference.

### BACKGROUND

(a) Technical Field

The present invention relates to a bubble removing device for an ion filter in a fuel cell system, and more particularly, to a bubble removing device in which bubbles generated from cooling water passing through an ion resin are easily removed and discharged outside the fuel cell system.

(b) Background Art

A fuel cell system within in a fuel cell vehicle generally includes a fuel cell stack, a fuel supply system for supplying a fuel (hydrogen) to the fuel cell stack, an air supply system for supplying the fuel cell stack with an oxidizer necessary for an electrochemical reaction (e.g., oxygen from the air), and a heat and water management system for controlling the operating temperature of the fuel cell stack.

The heat and water management system, as shown in FIG. 6, basically includes a cooling pump 14 for circulating cooling water to the fuel cell stack 12 and a radiator 16 for cooling the cooling water discharged after cooling the fuel cell stack 12. The system may further include an ion filter 10 positioned within the cooling water loop for filtering ions eluted from the cooling water.

Thus, cooling water is circulated in the fuel cell stack and is discharged through the ion filter 10 to remove metallic ions. This maintains the electric conductance of the cooling water at a low level and extends the lifespan of the fuel cell and the electric stability of the fuel cell system. To this end, the ion filter typically contains an ion resin in the form of minute particles that filter ions contained in the cooling water. For example, as shown in FIG. 5, the ion resin in the form of minute particles is embedded in the form of a cartridge inside a body portion 20 of the ion filter 10. A cooling water inlet 22, for supplying the cooling water to the ion resin, is formed in a bottom end of the body portion 20. A cover cap 24 disposed on a top end of the body portion 20 is provided with a cooling water outlet 26 for discharging the ion-filtered cooling water.

Therefore, after the cooling water circulates through the fuel cell stack 12, it is discharged from the fuel cell stack 12 and introduced to the body portion 20 through the cooling water inlet 22. As the cooling water passes through the ion resin, metallic ions are removed. The cooling water is then discharged through the cooling water outlet 22 of the cover cap 24 and is circulated back to the fuel cell stack 12.

However, as shown in FIG. 4, the ion filter 10 is located on a top portion of the heat and water management system. This results in the collection of bubbles in the cooling water.

In particular, although bubbles in the cooling water loop pass through the ion resin of the ion filter 10, and are collected in an internal space of the cover cap 24 located on the top end of the ion filter 10, the system does not provide for separate discharge of the bubbles and, thus, the bubbles are discharged through the cooling water outlet 26 together with the cooling water. As a result, the bubbles are circulated in the fuel cell system (the stack, the radiator, etc.).

When the bubbles passing through the ion filter 10 are circulated together with the cooling water, it takes about 2 or 3 days to remove the bubbles, and the bubbles are collected in the radiator. As a result, heat emission performance is degraded and noise is generated by the cooling water flow.

What is needed is a system and method for removing bubbles from cooling water circulating within fuel cell system, such that the heat emission efficiency of the fuel cell system is maintained

### SUMMARY OF THE DISCLOSURE

The present invention provides a bubble removing device for an ion filter for a fuel cell system. In particular, the present invention provides a bubble removing device in which a means for discharging bubbles outside a fuel cell system is installed in an ion filter located on a top portion of a fuel cell system. The bubble removing device easily discharges bubbles that are generated when cooling water passes through the ion filter , thereby maximizing power efficiency and heat emission efficiency of the fuel cell system.

According to an aspect of the present invention, a bubble removing device for an ion filter of a fuel cell system is provided, wherein the ion filter includes a cooling water inlet in a bottom end portion and an ion filter body portion having ion resin embedded therein. The bubble removing device includes a bubble removing means disposed at an inner top portion of the ion filter. The bubble removing means is positionable between an open or closed position with respect to the exterior of the ion filter, particularly by use of buoyancy.

According to various embodiments, the bubble removing means includes a bubble outlet formed in an upper portion (e.g. top end) of the ion filter, a ball departure preventing guide integrally formed on a peripheral portion of the bubble outlet inside the upper (top end) portion of the ion filter, and a ball which is positioned in the ball departure preventing guide so as to float upwards or downwards within the ball departure preventing guide the cooling water to thereby open or close the bubble outlet. In particular, when the ball is positioned in an upper portion of the ball departure preventing guide, it blocks off (closes) the bubble outlet. As the ball floats downwards, the bubble outlet is unblocked (opened) to allow discharge of bubbles.

The configuration of the ball is not particularly limited, provided that it is movable upwards and downwards within the ball departure preventing guide by the cooling water, and provided it is sized sufficiently to block off the bubble outlet when positioned in an upper portion of the ball departure preventing guide. According to various embodiments, the ball may have a heavier interior portion (e.g. a steel ball or the like) with a flexible coating material having buoyancy.

According to various embodiments, the ball departure preventing guide may include a ball transfer guide having a diameter which gradually decreases from top to bottom. As such, when the ball is in an upper portion of the ball transfer guide, it is in contact with the inner surfaces of the ball transfer guide to thereby prevent passage of bubbles between the ball and the inner surfaces of the ball transfer guide. A bottom portion of the ball transfer guide is configured to prevent the ball from floating downward out of the ball departure preventing guide and may, for example, include a stopper which may be formed by inwardly bent portions of the ball transfer guide. One or more bubble through holes are formed in a bottom portion of the ball transfer guide and/or one or more surfaces of the stopper.

### BRIEF DESCRIPTION OF THE DRAWINGS

The above and other features of the present invention will now be described in detail with reference to an exemplary embodiment thereof illustrated the accompanying drawings which are given herein below by way of illustration only, and thus are not limitative of the present invention, and wherein:

FIGS. 1 and 2 are cross-sectional views of a bubble removing device according to an embodiment of the present invention;

FIG. 3 is a cross-sectional view of a floating ball structure according to an embodiment of the present invention;

FIG. 4 is a schematic view showing a conventional installation position of an ion filter of a fuel cell system;

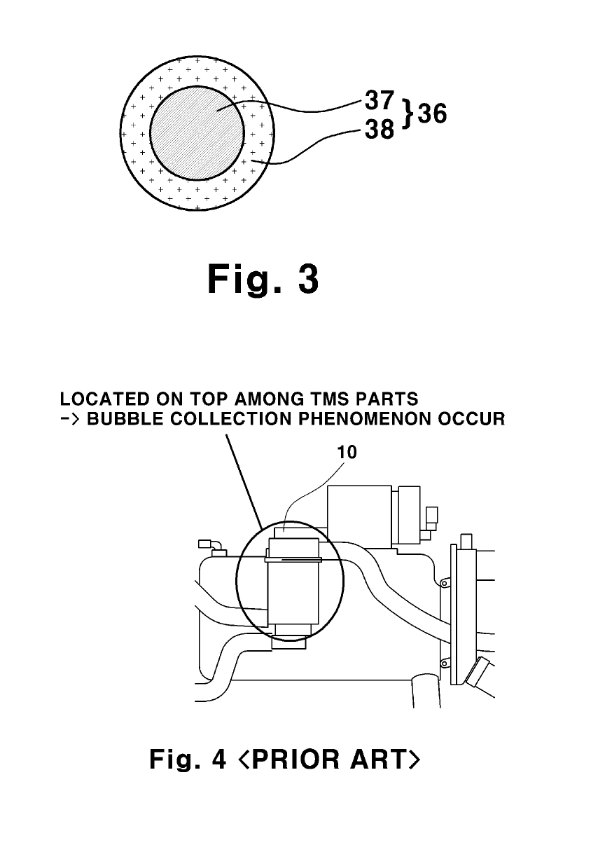

FIG. 5 is a perspective view showing an exterior of a conventional ion filter of a fuel cell system; and

FIG. 6 is a diagram showing a conventional fuel cell system in which an ion filter is disposed in a cooling water circulation path.

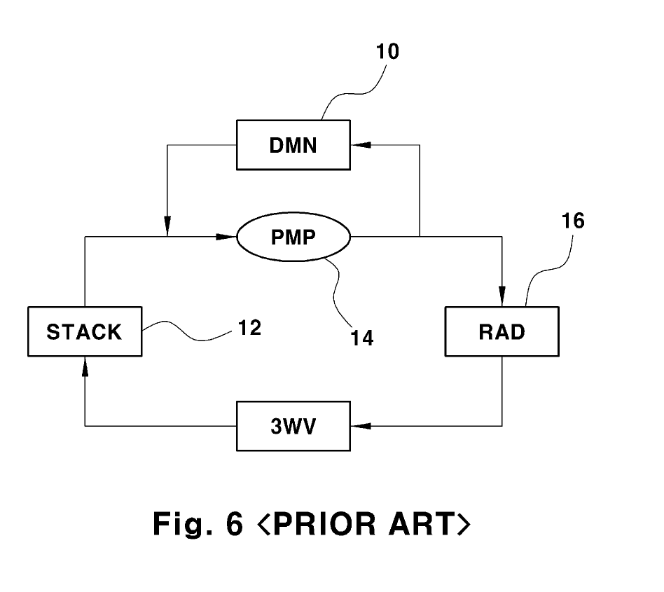

### DETAILED DESCRIPTION

Hereinafter, the present invention will be described in detail with reference to the accompanying drawings to allow those of ordinary skill in the art to easily carry out the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

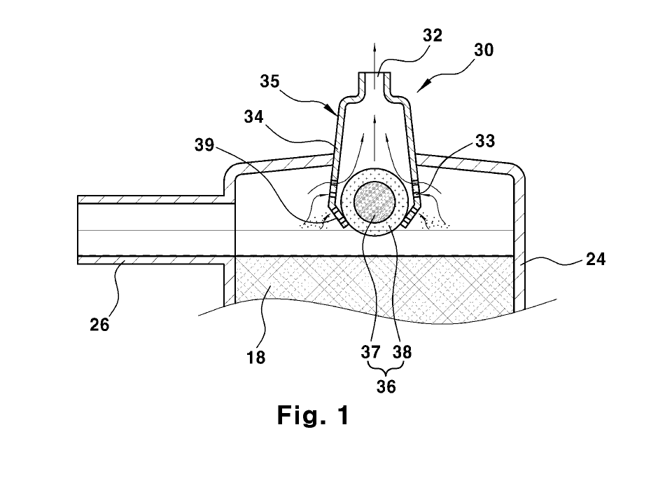

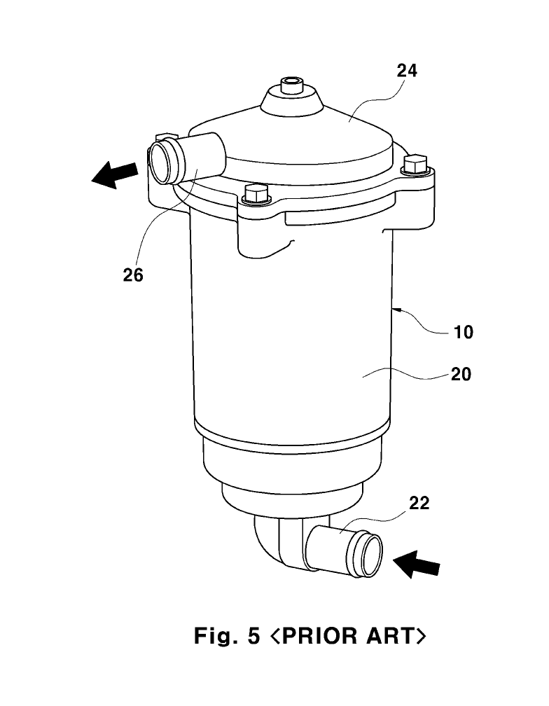

Referring to FIG. 5, the ion filter for a fuel cell system may generally include an ion filter body portion 20 having embedded therein ion resin 18 (see FIGS. 1 and 2), particularly a cartridge type ion resin 18, and a cover cap 24 disposed at a top end portion of the ion filter body portion 20.

A cooling water inlet 22, through which cooling water is introduced after circulation in a fuel cell stack, is formed on a bottom end portion of the ion filter body portion 20. A cooling water outlet 26, for discharging the cooling water which has passed through the ion resin 18, is provided on a side of the cover cap 24. Preferably, the cooling water outlet 26 is integrally formed in the cover cap 24.

Therefore, the cooling water discharged after circulation through the fuel cell stack is introduced to the ion resin 18 through the cooling water inlet 22. As the cooling water passes through the ion resin 18, the metallic ions of the cooling water are removed. The cooling water is then ejected to an internal space of the cover cap 24 located above the ion resin 18, and can thereafter be discharged through the cooling water outlet 26. The discharged cooling water is then circulated back to the radiator, the fuel cell stack, etc.

Because the ion filter 10 is located on a top portion of the heat and water management system, a lot of bubbles are generated in the cooling water as it passes through the ion resin 18 and is collected in the cover cap 24.

According to the present invention, to remove the bubbles from cooling water that has passed through the ion resin 18 and has been ejected to the internal space of the cover cap 24, a bubble removing means 30 is disposed in the cover cap 24. For example, as shown in FIGS. 1 and 2, the bubble removing means 30 can be disposed at an upper portion of the cover cap 24. The bubble removing means 30 is configured and arranged to be adjustable between and open and closed position relative to the exterior of the ion filter 10 such that bubbles can be discharged in the open position but not in the open position.

According to an embodiment, the bubble removing means 30 is configured to be adjustable between an open and closed position through buoyancy. In particular, the bubble removing means 30 can be configured and arranged such that buoyancy of cooling water within the ion filter 10 adjusts the bubble removing means 30 to either an open or closed position. For example, as shown in an exemplary embodiment in FIGS. 1 and 2, the bubble removing means 30 can be disposed at a top end portion of the cover cap 24 and in communication with cooling water flowing through the ion resin 18 and out through the cover cap 24. The bubble removing means 30 can, thus, be elevated or lowered by buoyancy of the cooling water to allow for or isolate from communication outside the system.

As shown in FIGS. 1 and 2, the bubble removing means 30 includes, as a main component, a ball 36 which is movable upwards and downwards through buoyancy of cooling water passing through the cover cap 24. In particular, the ball 36 configured and arranged such that it floats on the surface of the cooling water ejected into the cover cap 24. The ball 36 is elevated and lowered depending upon the cooling water level.

As further shown in FIGS. 1 and 2, a bubble outlet 32 through which the bubbles are discharged to the open air is formed at a top end tip of the cover cap 24.

As shown in FIGS. 1 and 2, the bubble removing means further includes a ball departure preventing guide 34 which houses the ball 36. In particular, the ball departure preventing guide 34 is in the form of a hollow structure extending vertically from a position above the ion resin 18 (and within a passageway through which cooling water flows) to a bubble outlet 32 disposed at the top of the cover cap 24. The ball departure preventing guide 34 may be integrally formed in the top end portion of the cover cap 24.

More specifically, as shown in FIGS. 1 and 2, the ball departure preventing guide 34 has a hollow structure with an interior a diameter which gradually decreases from top to bottom. The ball departure preventing guide 34, further includes a ball transfer guide 35 that allows the ball 36 to elevate or lower. A stopper 39 can further be provided at the bottom end of the ball transfer guide 35 to prevent the ball from exiting the bottom of the ball departure preventing guide 34. For example, as shown, the stopper 39 may be in the form of inwardly angled or bent extensions at the bottom of the ball transfer guide 35 which provide an opening that is smaller in diameter than the ball 36 diameter.

One or more bubble through holes 33 are provided in the ball transfer guide 35 and/or stopper 39 which allow bubbles from the cooling water to pass into the ball transfer guide 35. Preferably, for example, as shown in FIGS. 1 and 2, a plurality of holes are provided in the form of perforations in the bottom portion of the ball transfer guide 35 and in the stopper 39. For example, the entire surface of the stopper 39 may be provided with bubble through holes 33.

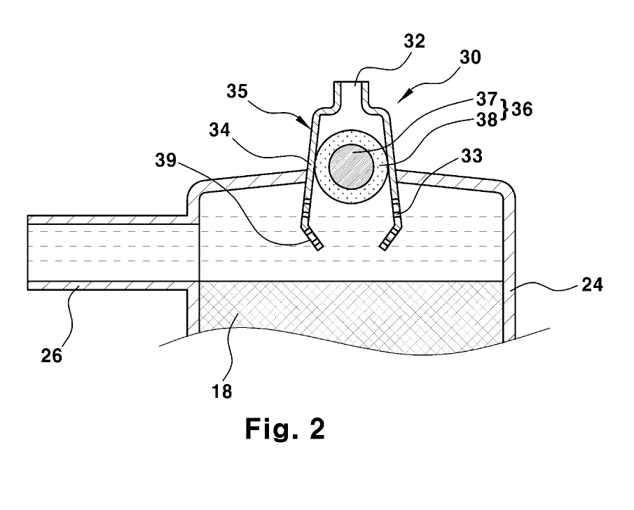

The ball 36 is configured so as to float by buoyancy on the surface of the cooling water. For example, as shown in FIG. 3, the ball 36 positioned in the ball departure preventing guide 34 may have a core shell structure with a core 37 formed from a heavier material, such as a steel ball, and a buoyant shell 37 which may be a flexible, such as Styrofoam. However, the ball 36 is not limited to such a core shell structure, and could be formed from a single material having buoyancy, and also flexibility if desired.

Hereinafter, an operating condition for the above-described bubble removing device will be described below.

First, the cooling water which is discharged after circulating through and cooling the fuel cell stack is introduced to the ion resin 18 through the cooling water inlet 20 in the bottom end of the body portion 20.

Next, the metallic ions contained in the cooling water are filtered by the ion resin 18 as the cooling water passes through the ion resin 18. The metallic-ion filtered cooling water is then ejected into the upper space of the cover cap 24.

In the depicted configuration, because the ion filter 10 is disposed on top in the heat and water management system, a lot of bubbles are generated in the cooling water passing through the ion resin 18. These bubbles collect in the upper space of the cover cap 24.

As shown in FIG. 1, when the level of cooling water in the upper space of the cooling cap 24 is low (e.g., when the cooling water has not yet been ejected into the upper space of the cover cap 24 or while the amount of cooling water ejected into the upper space of the cover cap 24 is small), then the ball 36 is at a low position within the ball transfer guide 35 (e.g., lowered down to the stopper 39 of the ball departure preventing guide 34 as shown in FIG. 1). In this position, the bubble outlet 32 formed in the top end portion of the cover cap 24 is in communication with the open air, and thus is opened.

Therefore, bubbles collected in the upper space of the cover cap 24 are easily discharged and removed to the outside by passing through bubble through holes 33 in bottom end portion of the ball transfer guide 35 and/or bubble through hole 33 in the stopper 39, and through the bubble outlet 32.

As shown in FIG. 2, as the cooling water level in the inner space of the cover cap 24 increases (e.g. the amount of the cooling water ejected into the inner space of the cover cap 24 increases), the ball 36 floats on the cooling water surface and is gradually elevated by buoyancy.

That is, the ball 36 is elevated upwards along an the ball departure preventing guide 34 (along an inner surface of the ball departure preventing guide 34 which may be provided with a gradually decreasing diameter from top to bottom) as the cooling water level is raised, until the ball 36 reaches a point in which its diameter is the same as the inner diameter of the ball transfer guide 35 (and, thus, cannot move upwards any further). At this point, as shown in FIG. 2, the ball 36 blocks the bubble outlet 32 formed on the top end portion of the cover cap 24.

In this position, the ball 36 blocks the bubble outlet 32 by upwards pressure from the cooling water, thereby easily preventing leakage phenomenon of the cooling water leaks outside.

In this position, the bubbles of the cooling water which have passed through the ion resin 18 of the ion filter 10 and have collected in the inner space of the cover cap 24, are easily discharged and removed through the bubble outlet 32. Further, the cooling water from which the bubbles have been removed is discharged through the cooling water outlet 26 of the cover cap 24 and is circulated along the cooling loop (the stack, the radiator, etc.) of the fuel cell system.

As a result, the cooling water from which the bubbles are removed in real time is circulated along the cooling loop, thereby maximizing the power efficiency and heat emission efficiency of the fuel cell system, and solving the flow noise problem caused by bubbles in the cooling water.

The present invention, thus, provides the following effects.

According to the present invention, a bubble removing means for discharging bubbles contained in cooling water of a fuel cell system utilizes a ball which is movable upwards and downwards through buoyancy of cooling water within the system. The bubble removing means may be is installed in an ion filter provided in a top position within the fuel cell system. The present bubble removing means is capable of discharges and removes the bubbles that are generated at a high concentration when the cooling water passes through the ion filter. Further, by providing a ball that opens and closes a bubble outlet based on the level of cooling water, air-tightness is provided and leakage of the cooling water is prevented.

The present bubble removing means is further configured and arranged to provide real-time bubble removal, which maximizes the power efficiency and heat emission efficiency of the fuel cell system, and further eliminates the flow noise problem often caused by bubbles in the cooling water.

[Description of Reference Numerals]

| | |
|---|---|
| 10: Ion Filter | 12: Fuel Cell Stack |
| 14: Cooling Pump | 16: Radiator |
| 18: Ion Resin | 20: Body Portion |
| 22: Cooling Water Inlet | 24: Cover Cap |
| 26: Cooling Water Outlet | 30: Bubble Removing Means |
| 32: Bubble Outlet | 33: Bubble Through Hole |
| 34: Ball Departure Preventing Guide | 35: Ball Transfer Guide |
| 36: Ball | 37: Core |
| 38: Shell | 39: Stopper |

What is claimed is:

1. A bubble removing device for an ion filter of a fuel cell system, in which the ion filter comprises a body portion having an upper end and a bottom end, a cooling water inlet disposed at the bottom end and an ion resin embedded within the body portion, comprising:
a bubble removing means disposed at the upper end of the body portion, the bubble removing means being movable by buoyancy between an opened or closed position with respect to an exterior of the ion filter .

2. The bubble removing device of claim 1, wherein the bubble removing means comprises:
a bubble outlet disposed at top end tip of the ion filter;
a ball departure preventing guide integrally formed on a peripheral portion of the bubble outlet and extending downwards with the top end of the ion filter; and
a ball disposed and vertically movable within the ball departure preventing guide,
whereby the ball is movable upwards by buoyancy of cooling water within the top end of the ion filter, to thereby open or block the bubble outlet.

3. The bubble removing device of claim 2, wherein the ball has a core shell structure, and the core is fabricated of a flexible material having buoyancy.

4. The bubble removing device of claim 3, wherein the core is in the form of a steel ball.

5. The bubble removing device of claim 2, wherein the ball departure preventing guide comprises a ball transfer guide having a diameter which gradually decreases from top to bottom, and one or more bubble through holes in a bottom portion of the ball transfer guide.

6. The bubble removing device of claim 5, wherein the ball transfer guide further comprises a stopper at a bottom portion, the stopper configured to prevent the ball from passing therethrough.

7. The bubble removing device of claim 6, further comprising one or more bubble through holes in the stopper.

8. The bubble removing device of claim 6, wherein the stopper comprises inwardly bent formed on a bottom end portion of the ball transfer guide.

9. An ion filter for a fuel cell comprising:
a body portion having an upper end and a bottom end;
a cooling water inlet disposed at the bottom end;
an ion resin embedded within the body portion; and a bubble removing device of claim 1 disposed at the upper end of the body portion.
